(19) United States
(12) Patent Application Publication
(10) Pub. No.: US 2007/0247433 A1
(43) Pub. Date: Oct. 25, 2007

(54) Operating method and apparatus for a portable electronic device

(75) Inventor: Kai-Wu Li, Shanghai City (CN)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/647,465

(22) Filed: Dec. 29, 2006

(30) Foreign Application Priority Data
Apr. 21, 2006 (TW) 95114411

(51) Int. Cl. G09G 5/00

(52) U.S. Cl. 345/169

(57) ABSTRACT

An operating method and apparatus are applied to a portable electronic device for performing plural touch operating modes and a press operating mode. In this method, the portable electronic device is first to determine whether the touch keypad is touched or not. Then, it is determined whether the metal dome is pressed or not. If the resilient metal dome under the touch keypad is pressed, the press operating mode is entered. Otherwise, one of the plural touch operating modes is entered and a touch locus of user touching is detected.

### BACKGROUND OF THE INVENTION

(1) Field of the Invention

The present invention relates to an operating method and apparatus for a portable electronic device. More particularly, the invention relates to an operating method and apparatus, by which a user may operate the portable electronic device with one hand or one finger.

(2) Description of the Prior Art

Please refer to FIG. 1A, which illustrates a smart phone 1 of prior art. The smart phone 1 comprises a touch panel 11, a keypad 12 and a touch pen 13 (i.e. stylus), and the touch panel 11 further comprises two displaying portions 11a and 11b.

The keypad 12 is composed of a plurality of express keys, which provide a user to switch around various operating modes. While the user needs to dial a phone number, the displaying portion 11b of the touch panel 11 can display a dial key pattern as shown in FIG. 1A for the user to touch with his/her fingers or the touch pen 13. Moreover, while the user needs to edit messages, he/she can switch to a specific operating mode through the keypad 12, and the displaying portion 11b of the touch panel 11 would display another key pattern as shown in FIG. 1B. The user may input characters through fingers or the touch panel 13, and the characters corresponding to the input operation is displayed in the displaying portion 11b as FIG. 1B shows.

In addition to the two operating modes mentioned above, the user may also touch the touch panel 11 with his/her fingers or the touch pen 13 to retrieve a function menu of the smart phone 1 to further perform other operation selections such as a phonebook, a calendar, or a message editor.

The smart phone with a touch panel can present powerful functions, but the maneuvering toward those functions usually needs to voyage through complex operating process. Therefore, a smart phone having both powerful functions and simple operating process is the one in the art to be looking forward.

### SUMMARY OF THE INVENTION

An object of the present invention is to provide an operating method of a portable electronic device so as to switch around different operating modes quickly.

Another object of the present invention is to provide an operating method which allows a user to operate multiple functions of a portable electronic device in one hand.

In accordance with the present invention, the portable electronic device to carry the operating method comprises at least a touch operating mode and a press operating mode. Firstly, the operating method of the portable electronic device is to judge whether the touch keypad is touched or not. Then, it is also judged whether a metal dome of the electronic device is pressed or not. In the case that the metal dome is pressed, the press operating mode is called or waked up. On the other hand, in the case that the metal dome is not pressed, one of the plural touch operating modes is introduced and a touch locus for possible touch is continuously detected.

Another object of the present invention is to provide an operating method of performing plural operating modes for a portable electronic device. The portable electronic device comprises a touch keypad and a resilient metal dome disposed under the touch keypad. The plural operating modes comprise plural first operating modes and a second operating mode. The operating method comprises the steps of: entering a predetermined mode; determining whether the predetermined mode is one of the plural first operating modes; when the predetermined mode is one of the plural first operating modes, detecting a first position where a touch operation is made by a user; detecting a second position where the touch operation is finished by the user; determining whether the first position is equal to the second position or not; when the first position is equal to the second position, determining whether the first position is pressed to enter the press operating mode; when the first position is not equal to the second position, figuring out a sliding direction from the first position to the second position; displaying a pointer on a screen according to the sliding direction; when the predetermined mode is the second operating mode, detecting whether a press operation is executed or not; when the press operation is executed, determining a press region corresponding to the press operation; and performing a corresponding function according to the press region.

Another object of the present invention is to provide an apparatus for performing plural operating modes on a portable electronic device. The plural operating modes comprises plural first operating modes and a second operating mode. The apparatus comprises a touch keypad electrically connected to the portable electronic device; a press keypad having a resilient metal dome electrically connected to the portable electronic device, and the press keypad disposed under the touch keypad; and a pointer displayed on a screen; wherein when the touch keypad is touched, the plural first operating mode is performed, and when the press keypad is pressed, the second operating mode is performed.

In accordance with the present invention, when the touch keypad is touched, a starting contact position and a terminal contact position of the touch operation are detected sequentially, a slide angle and a slide direction are calculated according to the starting contact position and the terminal contact position, and the pointer is moved on the screen corresponding to the slide angle and the slide direction.

In accordance with the present invention, when the press keypad is pressed, a press region is determined, and a corresponding function is performed according to the press region.

### BRIEF DESCRIPTION OF THE DRAWINGS

Other features and advantages of this invention will become more apparent in the following detailed description of the preferred embodiments of this invention, with reference to the accompanying drawings, in which:

FIGS. 1A˜1B illustrate two states of a smart phone in the art;

FIG. 2 illustrates schematically an embodiment of a portable electronic device in accordance with the present invention;

FIG. 3 shows a flow chart of one embodiment of the switching process of the smart phone;

FIG. 4 illustrates how the smart phone can enter different operating modes;

FIG. 5 shows a flow chart of an operating process in accordance with the present invention;

FIG. 6 shows a functional flow of the press operating mode of the present invention;

FIG. 7 illustrates a flow chart of a media navigation operating mode of the present invention; and

FIGS. 8A˜8D are diagrams to show how the smart phone is operated to make a phone call.

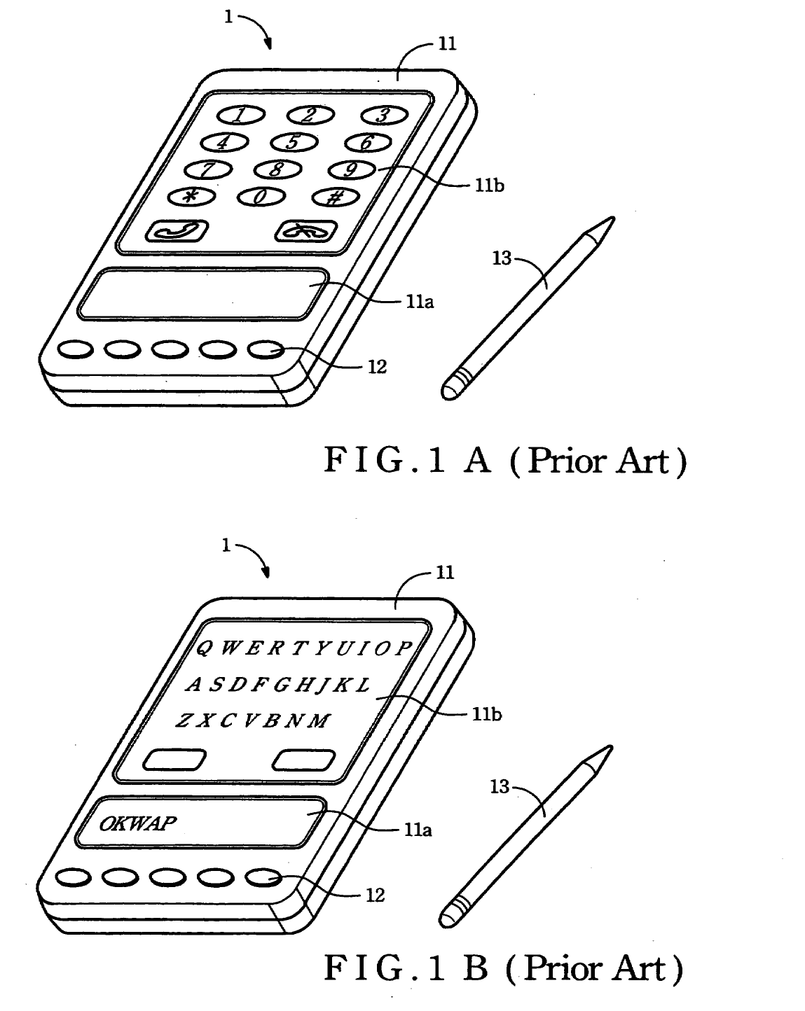

### DESCRIPTION OF THE PREFERRED EMBODIMENT

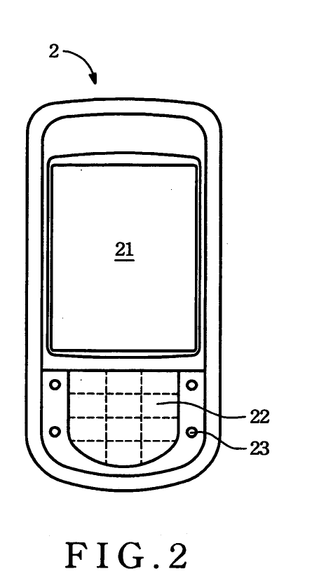

Please refer to FIG. 2, which illustrates a preferred embodiment of a portable electronic device in accordance with the present invention. Herein, the portable electronic device is a smart phone 2. The smart phone 2 comprises a displaying screen 21, a touch keypad 22 and a plurality of express keys 23. Moreover, the smart phone 2 comprises plural touch operating modes and a press operating mode. While the user touches the touch keypad 22 and slides on the touch keypad 22, he/she may enforce selection of various touch operating modes with one hand or one finger. While the user further presses the keypad 22 and pushes down a resilient metal dome disposed under the touch keypad 22, the operation mode can be switched to the press operating mode, and then the user may simply use one hand or one finger to maneuver around various operating modes of the smart phone 2.

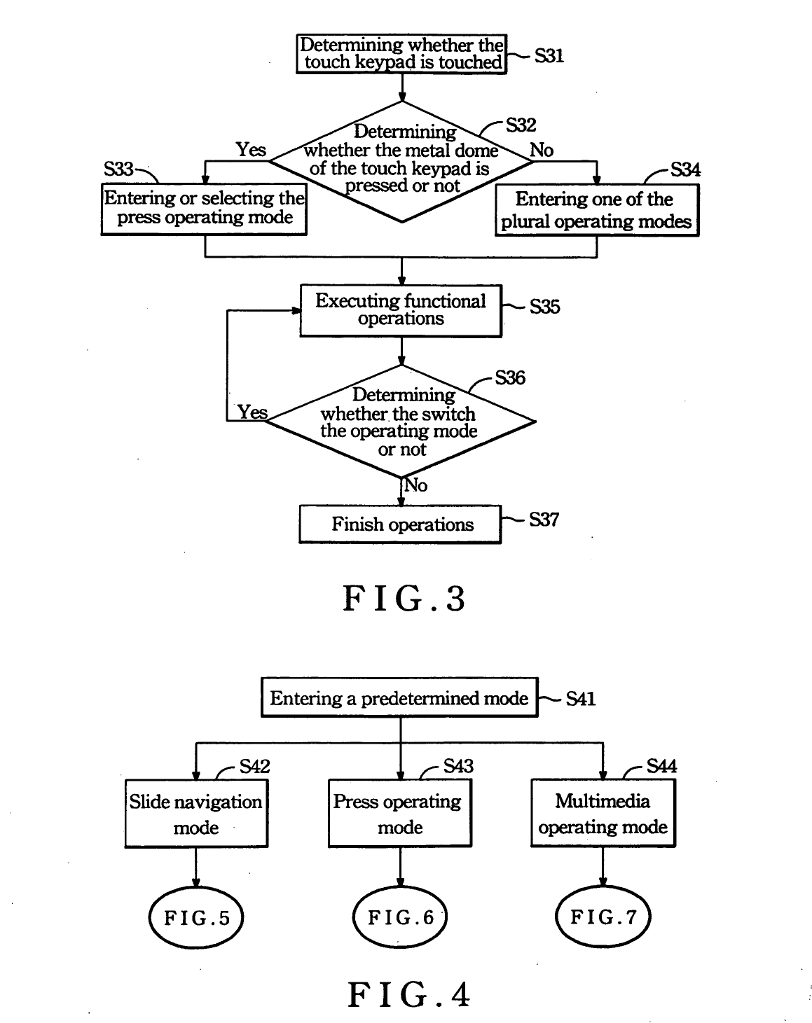

Please refer to FIG. 3, which shows the flow chart of switching process of the smart phone 2 in accordance with the present invention. The switching process comprises steps as follows:

Step 31 (S31): Determining whether the touch keypad 22 is touched. If positive, go on to step 32.

Step 32 (S32): Determining whether the resilient metal dome of the touch keypad 22 is pressed or not. If positive, go on to step 33. If negative, go on to step 34.

Step 33 (S33): Entering or selecting the press operating mode.

Step 34 (S34): Entering one of the plural touch operating modes and detecting a touch locus.

Step 35 (S35): Executing a variety of functional operations.

Step 36 (S36): Determining whether continue to switch the operating mode or not. If positive, switch another operating mode and then execute functional operations (back to step 35). If negative, go to step 37.

Step 37 (S37): Finish operations.

Through operating processes introduced above, the operating of the present smart phone 2 is much more simple than the prior art. Please further refer to FIG. 4, which illustrates how the smart phone 2 enters different kinds of operating modes. The processes shown in FIG. 4 comprise the following steps.

Step 41 (S41): Entering a predetermined mode. Herein, the predetermined mode could be the mode that is manually set or preset by the user, or the mode having the highest using rate during a past period.

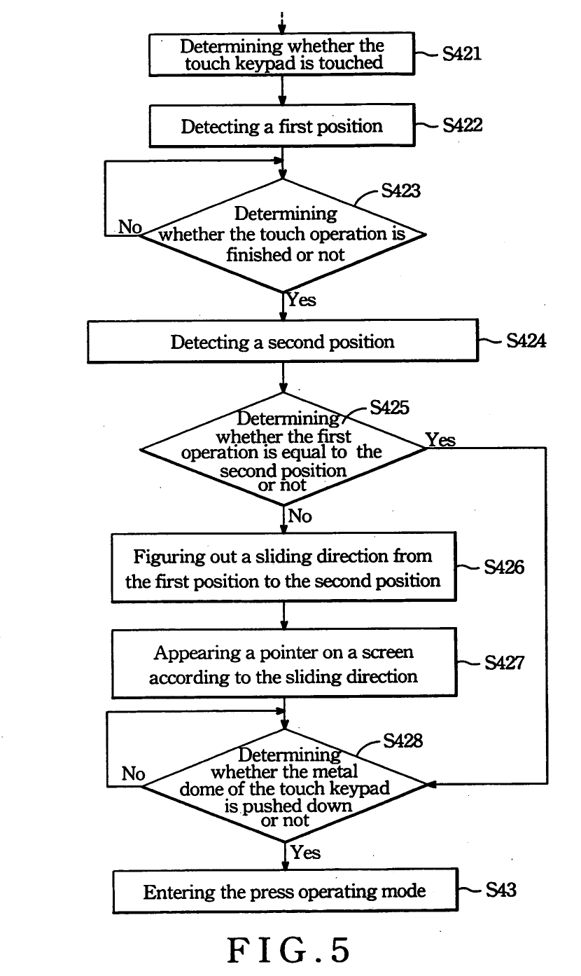

Step 42 (S42): If the predetermined mode is a slide navigation mode, go on to step 421 as shown in FIG. 5. The slide navigation mode includes sliding on the touch pad and searching a position information with one hand or one finger.

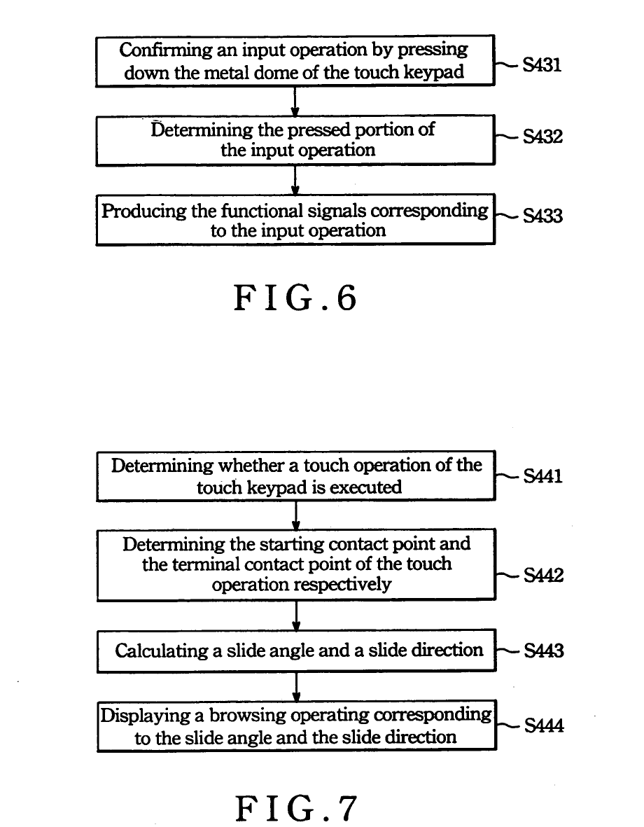

Step 43 (S43): If the predetermined mode is a press operating mode, go on to step 431 as shown in FIG. 6. The press operating mode includes pressing the keys of the touch keypad and performing a function corresponding to the pressed keys.

Step 44 (S44): If the predetermined mode is a multimedia operating mode, go on to step 441 as shown in FIG. 7. The multimedia operating mode includes sliding on the touch keypad and browsing multimedia functions with one hand or one finger. The sliding distance for the multimedia operating mode is longer than the sliding distance for the slide navigation mode.

Please refer to FIG. 5, which shows an operating process of one embodiment of the present invention. The process in FIG. 5 comprises the step of:

Step 421 (S421): Determining whether the touch keypad 22 is touched(S421);

Step 422 (S422): Detecting a first position where a touch operation is made by a user, wherein the first position is defined as the first contact point that the user contacts the touch keypad 22 (S422);

Step 423 (S423): Determining whether the touch operation is finished or not; going to step 424 if positive, or continuously determining until the finger lifts away the touch keypad 22 (S423);

Step 424 (S424): Detecting a second position, in which, in accordance with the present invention, the second position may be defined as the last contact point that the user contacts the touch keypad 22 (S424);

Step 425 (S425): Determining whether the first position is equal to the second position or not; going to step 428 if positive, or going to step 426;

Step 426 (S426): Figuring out a sliding direction from the first position to the second position (S426);

Step 427 (S427): Displaying a pointer on a screen according to the sliding direction, in which the pointer may move all around the displaying screen of the smart phone 2 (S427); and

Step 428 (S428): Determining whether the resilient metal dome of the touch keypad 22 is pushed down or not; entering the press operating mode as step 43 if positive, or the user may proceed viewing operations or finished the operation.

In accordance with the procedures mentioned above, it can be seen that the present invention provides a simple and easy one-hand method for any user to operate content browsing or function switching for the smart phone. After the user glances a specific profile that he/she wants to operate, he/she just has to press the touch keypad with a slight strength, and then the operation will be automatically switched to the press operating mode, with no other redundant extra-procedures.

Please refer to FIG. 6, which shows a functional flow diagram of the press operating mode of the present invention, in which:

S431: Confirming an input operation by pressing down the resilient metal dome of the touch keypad;

S432: Determining the pressed portion of the input operation; and

S433: Producing the functional signals corresponding to the input operation.

The press operating mode may work as a dialing mode, and the user may input phone number characters by way of repeating step 431˜step 433. The press operating mode may cooperate with the touch operating mode. For example, the user may find out the target content through the touch operating mode firstly, and then execute a target signal through the press operating mode.

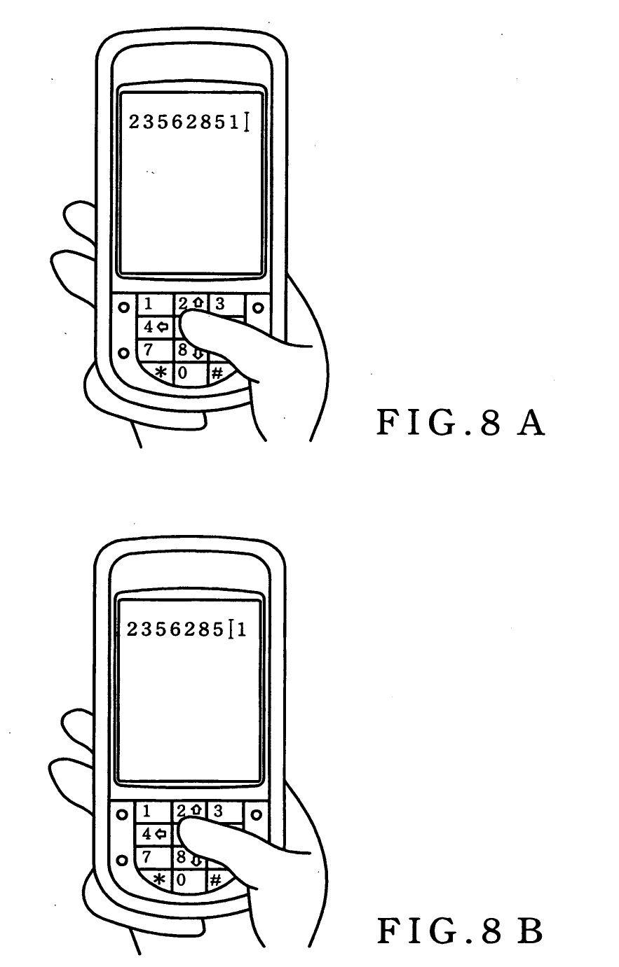

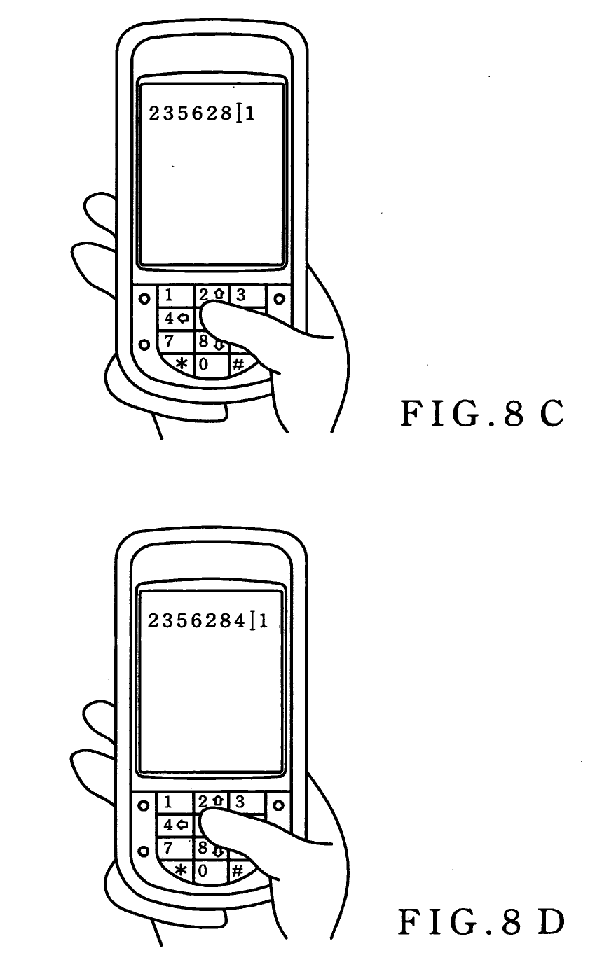

Please refer to FIGS. 8A˜8D, which are diagrams while the smart phone 2 is making a phone call. In this embodiment, the phone number that the user originally wants to input is, for example, 23562841. However, as shown in FIG. 8A, if one of the phone number characters is mis-input, as the phone number 23562851 shown in FIG. 8A, the user may use his/her finger to slide on the surface of the touch keypad 22 to correct the phone number. As shown in FIG. 8B, the user may use his/her finger to slide from the right side to the left side on the surface of the touch keypad 22. The finger can slide from the character 5 to the character 4 so as to move the pointer toward the position between the character 4 and the character 1. Then, the user may delete the character 5, as shown in FIG. 8C, to have the number string shown as 2536281. The user can then input the character 4 through the press operating mode to have the correct phone number 23562841, and the input process is finished, as shown in FIG. 8D.

The processes mentioned above illustrate that the method of the present invention is convenient and flexible in processing with one hand or one finger, and the mode switching is simple and easy for using with one hand or one finger.

The present invention can move the pointer smoothly, and it can also be applied to browse multimedia functions quickly. Please refer to FIG. 7, which illustrates a flow chart of a multimedia operating mode in accordance with an embodiment of the present invention. The procedures shown in FIG. 7 comprise the steps as follows.

(S441) Determining whether a touch operation of the touch keypad is executed. The touch operation herein is a long distance sliding in a clockwise direction or a counter clockwise direction compared to the short distance sliding of the slide navigation operation.

(S442) Detecting the starting contact position and the terminal (or final) contact position of the touch operation, respectively.

(S443) Calculating a slide angle and a slide direction according to the starting contact position and the terminal contact position.

(S444) Browsing multimedia functions on the portable electronic device according to the slide angle and the slide direction, and the browsed multimedia function is displayed.

The multimedia operating mode provides the user functions of quickly switching and moving the position of the pointer under table of contents, and easily amplifying or lessening pictures or characters under specific catalog or table, etc.

In the present invention, the multiple software of performing the multiple operating modes for the touch keypad 22 could be cooperated with other modes. For instance, a handwriting mode or a mouse operating mode could be cooperated with the present multiple software for performing the multiple operating modes.

To sum up, the present invention provides an operating method for integrating multiple operating modes simply, and provides switching processes between different operating modes that could be performed simply and conveniently with one hand or one finger.

While the present invention has been particularly shown and described with reference to such preferred embodiments, it will be understood by those skilled in the art that various changes in form and detail may be without departing from the spirit and scope of the present invention.

What is claimed is:

1. An operating method of performing plural operating modes for a portable electronic device, the portable electronic device comprising a touch keypad and a resilient metal dome, the plural operating modes having plural first operating modes and a second operating mode, the method comprising the steps of:
determining whether the touch keypad is touched or not;
when the touch keypad is touched, determining whether the resilient metal dome is pressed or not;
when the metal dome is pressed, performing the second operating mode; and
when the metal dome is not pressed, performing one of the plural first operating modes and detecting a touch locus according to a user touching position.

2. The operating method of claim 1, wherein the portable electronic device is a smart mobile phone.

3. The operating method of claim 1, wherein the second operating mode comprises a press operating mode, the press operating mode including pressing the keys of the touch keypad and performing a function corresponding to the pressed keys.

4. The operating method of claim 1, wherein the plural first operating modes comprise a slide navigation mode, a multimedia operating mode, a handwriting mode and a mouse operating mode, the slide navigation mode including sliding and searching a position information on the touch pad with one hand or one finger, the multimedia operating mode including sliding and browsing multimedia functions on the touch pad with one hand or one finger, and the sliding distance of the multimedia operating mode is longer than the sliding distance of the slide navigation mode.

5. An operating method of performing plural operating modes for a portable electronic device, the portable electronic device comprising a touch keypad and a resilient metal dome, the plural operating modes having plural first operating modes and a second operating mode, the operating method comprising the steps of:
entering a predetermined mode;
determining whether the predetermined mode is one of the plural first operating modes;
when the predetermined mode is one of the plural first operating modes,
detecting a first position where a touch operation is made by a user;
detecting a second position where the touch operation is finished by the user;
determining whether the first position is equal to the second position or not;
when the first position is equal to the second position, determining whether the first position is pressed to enter the press operating mode;
when the first position is not equal to the second position, figuring out a sliding direction from the first position to the second position;
displaying a pointer on a screen according to the sliding direction;
when the predetermined mode is the second operating mode,
detecting whether a press operation is executed or not;
when the press operation is executed, determining a press region corresponding to the press operation; and
performing a corresponding function according to the press region.

6. The operating method of claim 5, wherein the plural first operating modes comprises a multimedia operating mode, and the multimedia operating mode comprises:
determining whether the touch keypad is touched;
detecting a starting contact position and a terminal contact position of the touch operation respectively;
calculating a slide angle and a slide direction according to the starting contact position and the terminal contact position; and
displaying a browsing operation corresponding to the slide angle and the slide direction.

7. The operating method of claim 5, wherein the process of entering a predetermined mode is manually set by the user.

8. The operating method of claim 5, wherein the process of entering a predetermined mode is preset by the user.

9. The operating method of claim 5, wherein the predetermined mode is a mode that has the highest utility rate.

10. The operating method of claim 5, wherein the portable electronic device is a mobile phone.

11. The operating method of claim 6, wherein the plural first operating modes comprises a slide navigation mode, and the slide navigation mode comprises:
determining whether the touch keypad is touched;
detecting a first position which is a first contact point that the user contacts the touch keypad;
detecting a second position which is a last contact point that the user contacts the touch keypad;
determining whether the first position is equal to the second position;
When the first position is not equal to the second position, figuring out a sliding direction from the first position to the second position; and
displaying a pointer on a screen according to the sliding direction.

12. The operating method of claim 11, wherein the plural first operating modes comprises a slide navigation mode, a multimedia operating mode, a handwriting mode and a mouse operating mode.

13. An apparatus for performing plural operating modes on a portable electronic device, the plural operating modes having plural first operating modes and a second operating mode, the apparatus comprising:
a touch keypad electrically connected to the portable electronic device;
a press keypad having a resilient metal dome electrically connected to the portable electronic device, and the press keypad disposed under the touch keypad; and
a pointer displayed on a screen;
wherein when the touch keypad is touched, the plural first operating mode is performed, and when the press keypad is pressed, the second operating mode is performed.

14. The apparatus of claim 13, wherein when the touch keypad is touched, a starting contact position and a terminal contact position of the touch operation are detected sequentially, a slide angle and a slide direction are calculated according to the starting contact position and the terminal contact position, and the pointer is moved on the screen corresponding to the slide angle and the slide direction.

15. The apparatus of claim 13, wherein when the press keypad is pressed, a press region is determined, and a corresponding function is performed according to the press region.
